(19) United States
(12) Patent Application Publication
(10) Pub. No.: US 2021/0398268 A1
(43) Pub. Date: Dec. 23, 2021

(54) REMOTE VISUALLY ENABLED CONTRACTING

(71) Applicant: Peter L. Rex, Bellevue, WA (US)

(72) Inventor: Peter L. Rex, Bellevue, WA (US)

(21) Appl. No.: 17/353,733

(22) Filed: Jun. 21, 2021

Related U.S. Application Data
(63) Continuation-in-part of application No. 17/242,799, filed on Apr. 28, 2021.
(60) Provisional application No. 63/041,524, filed on Jun. 19, 2020.

(51) Int. Cl. G06T 7/00; G06T 7/11; G06T 7/50; G06T 19/00; G06Q 50/16

(52) U.S. Cl. CPC G06T 7/0004; G06T 7/11; G06T 2207/30184; G06T 19/00; G06Q 50/163; G06T 7/50

(57) ABSTRACT

At least one computer-readable medium on which are stored instructions that, when executed by one or more processing devices, enable the one or more processing devices to perform a method. The method includes the steps of receiving from a user one or more virtual-reality images of a structure, performing on the image a first image recognition routine, the first image recognition routine identifying in the image a first object of which the structure is comprised, performing on the image a second image recognition routine, the second image recognition routine identifying in the image one or more defects in the first object, and generating an estimate of a type and quantity of material necessary to remedy the identified one or more defects.

### PRIORITY CLAIM

This applications claims priority from U.S. Provisional Patent Application Ser. No. 63/041,524 filed Jun. 19, 2020, the entirety of which is hereby incorporated by reference as if fully set forth herein. This application is a continuation-in-part of U.S. patent application Ser. No. 17/242,799 filed Apr. 28, 2021, the entirety of which is also hereby incorporated by reference as if fully set forth herein.

### BACKGROUND

Conventionally, home and property repair services require a service professional to visit the home or property before being able to assess the damage to the home property and the type and amount of materials that will be required to provide the repair service.

Some of the problems associated with property diagnostic and repair services include travel costs in identification, diagnosis, scoping, and advisory of property related projects and maintenance, the difficulty experienced by a customer of being able to instantly connect with a field expert and receive advisory or estimate of costs, a feeling of insecurity for the customer in requiring a person they don't know to enter their property, and distribution of knowledge globally, which today is almost always only accessed on a local level by a local professional.

### DRAWING FIGURES

FIG. 1 is a schematic view of an exemplary operating environment in which an embodiment of the invention can be implemented;

FIG. 2 is a functional block diagram of an exemplary operating environment in which an embodiment of the invention can be implemented; and

FIG. 3 schematically illustrates a process according to an embodiment of the invention.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be described in the general context of computer-executable instructions, such as program modules, being executed by a processing device having specialized functionality and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such trap formation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

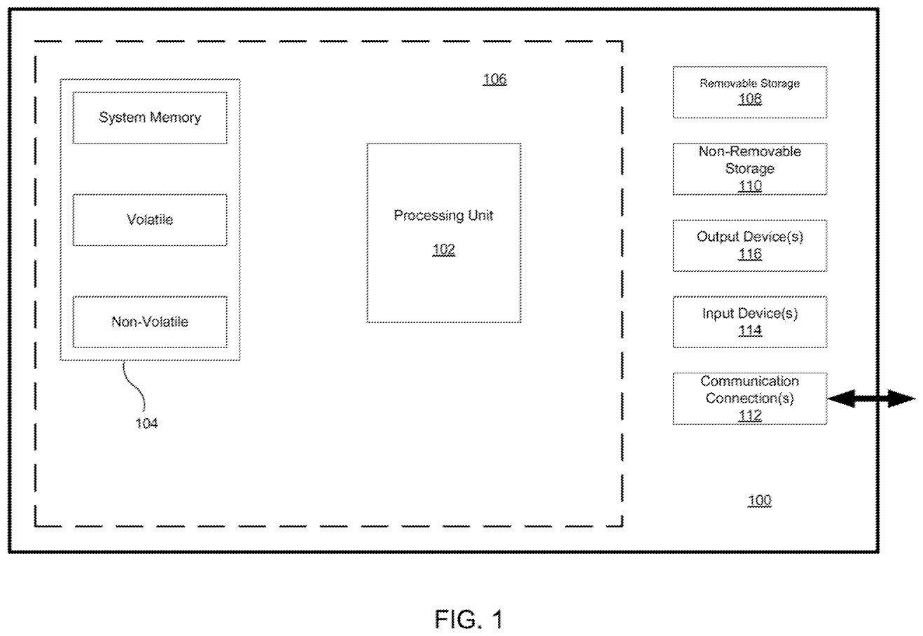

With reference to FIG. 1, an exemplary system for implementing an embodiment of the invention includes a computing device, such as computing device 100, which, in an embodiment, is or includes a smartphone. The computing device 100 typically includes at least one processing unit 102 and memory 104.

Depending on the exact configuration and type of computing device, memory 104 may be volatile (such as random-access memory (RAM)), nonvolatile (such as read-only memory (ROM), flash memory, etc.) or some combination of the two. This most basic configuration is illustrated in FIG. 1 by dashed line 106.

Additionally, the device 100 may have additional features, aspects, and functionality. For example, the device 100 may include additional storage (removable and/or non-removable) which may take the form of, but is not limited to, magnetic or optical disks or tapes. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

The device 100 may also include a communications connection 112 that allows the device to communicate with other devices. The communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, the communication media includes wired media such as a wired network or direct-wired connection, and wireless media such as acoustic, radio-frequency (RF), infrared, cellular and other wireless media. The term computer-readable media as used herein includes both storage media and communication media.

The device 100 may also have an input device 114 such as keyboard, mouse, pen, voice-input device, touch-input device, etc. Further, an output device 116 such as a display, speakers, printer, etc. may also be included. Additional input devices 114 and output devices 116 may be included depending on a desired functionality of the device 100.

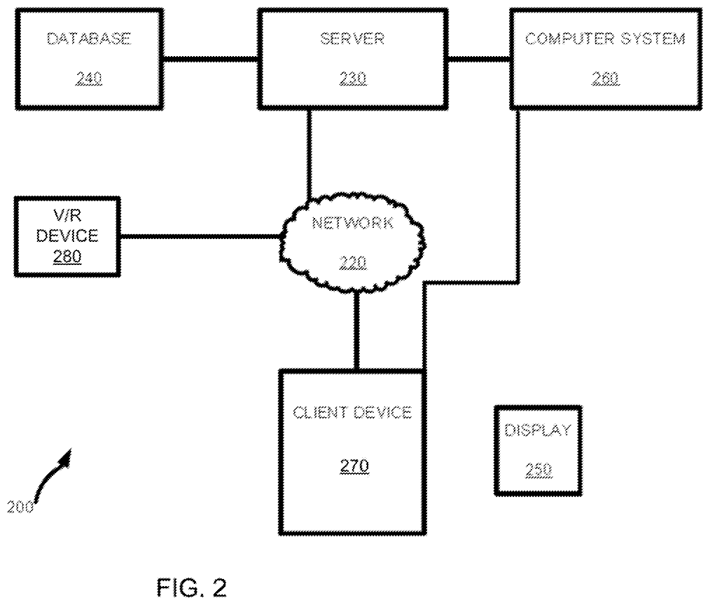

Referring now to FIG. 2, an embodiment of the present invention may take the form, and/or may be implemented using one or more elements, of an exemplary computer network system 200 that, in an embodiment, includes a server 230, database 240 and computer system 260. The system 200 may communicate with an electronic client device. 270, such as a personal computer or workstation, virtual-reality (VR) image-capturing device (camera), tablet and/or smartphone, that is linked via a communication medium, such as a network 220 (e.g., the Internet), to one or more electronic devices or systems, such as server 230. The server 230 may further be coupled, or otherwise have access, to a database 240 and a computer system 260. Although the embodiment illustrated in FIG. 2 includes one server 230 coupled to one client device 270 via the network 220, it should be recognized that embodiments of the invention may be implemented using one or more such client devices coupled to one or more such servers.

The client device 270 and the server 230 may include all or fewer than all of the features associated with the device 100 illustrated in and discussed with reference to FIG. 1. The client device 270 includes or is otherwise coupled to a computer screen or display 250. The client device 270 may be used for various purposes such as network- and local-computing processes.

The client device 270 is linked via the network 220 to server 230 so that computer programs, such as, for example, a short message service (SMS) application, running on the client device 270 can cooperate in two-way communication with server 230. The server 230 may be coupled to database 240 to retrieve information therefrom and to store information thereto. Database 240 may have stored therein data (not shown) that can be used by the server 230 and/or client device 270 to enable performance of various aspects of embodiments of the invention. The data stored in database 240 may include, for example, standard dimensions of architectural structures (e.g., doorways, windows, etc.) and/or dimensions of other objects (e.g., furniture or other household objects) that may ordinarily be found on a real estate parcel. Additionally, the server 230 may be coupled to the computer system 260 in a manner allowing the server to delegate certain processing functions to the computer system. In an embodiment, most or all of the functionality described herein may be implemented in a desktop or smartphone application that may include one or more executable modules. In an embodiment, the client device 270 may bypass network 220 and communicate directly with computer system 260.

An embodiment provides visual recognition technology applied photos/images of property to identify a need for repairs, identify preventative measures that can mitigate, if not eliminate, issues detrimental to property, price materials, suggest a scope of work, identify materials including exact colors needed for matching, etc. Online databases (Google®, Home Depot®, etc.) can be heavily used in conjunction with an increasingly vast amount of proprietary data collected. An embodiment can leverage machine learning using smart algorithms to better and more accurately suggest, route, price etc.

An embodiment of the invention includes a method of diagnosing problems, scoping work, and providing service consulting in the field of property services/goods. An embodiment provides the use of video calling via built-in camera to bring a property services expert virtually on site to a customer's property. An embodiment enables an expert professional to provide services remotely on personal computer or by a virtual reality headset, by leveraging a local application by another of a technology such as a mobile phone camera live video device (e.g., Facetime, or Zoom Video) to identify, diagnose, scope, and or advise property related services or goods regarding property damage at a site without physically visiting the site.

One or more embodiments may employ the following technologies: camera hardware, VR camera and/or viewing device, visual/pattern recognition software, machine learning, GPS, and at least one database.

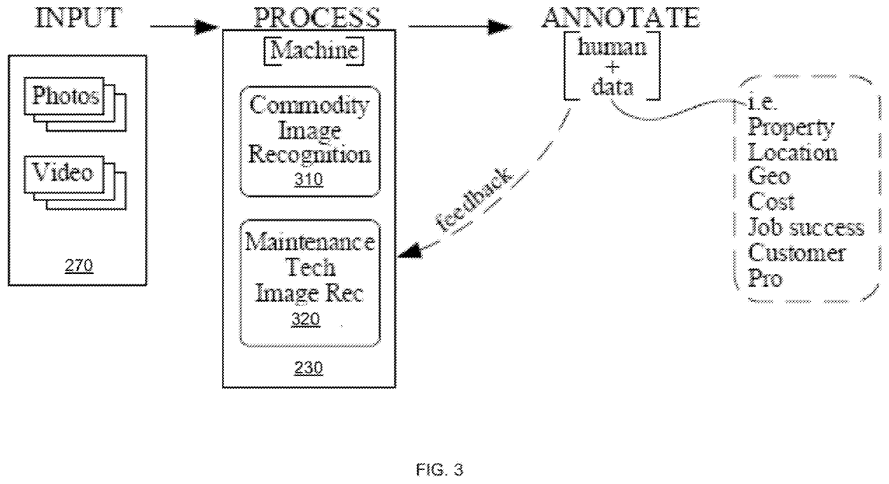

In an embodiment, and referring to FIG. 3, digital or digitized photos and videos, which may include images captured by VR image-capturing deice/camera components, are submitted by, for example, client device 270 to the server 230 of system 200 as part of a service request, a service update, or a key status change fin the service (e.g., job complete). Photos are analyzed and processed by an image-recognition module 310 to identify standard objects and a maintenance and repair image recognition (MAR) module 320 according to an embodiment. This MAR module 320 is enriched by human annotation combined with machine learning to be able to automatically recognize maintenance and repair needs based on images.

For example, assume the system 200 receives a photo of a living room. The image-recognition module 310 can identify all of the objects in the picture (e.g., wall, stairs, doorway, couch, table, etc.). The MAR module 320 can recognize that, for example, the wall and ceiling are damaged by water from a leak. The MAR module 320 according to an embodiment may be refined and iterated, using the annotation system discussed herein below for example, to be very strong at recognizing home maintenance and repair circumstances. This MAR module 320 according to an embodiment can also perform additional steps related to the recognized repair, as illustrated by the following examples.

If a wall and ceiling are damaged and need repair, MAR module 320 can automatically estimate the dimensions of the drywall needed for the repair using one or more other items in the image, such as doorways, windows or items of furniture, for example, as reference points. As such, in this example, by consulting standard dimensions of architectural structures (e.g., standard width of doorways) that may be stored in database 240, MAR module 320 can compare the dimensions of the damaged area with those of the detected architectural structure(s) and estimate the amount of material needed to make the repair.

In yet another example, if a fence repair is needed, MAR module 320 can estimate the dimensions of the damage to the fence and, using the standard fence-plank dimensions (e.g., length and height), which may be stored in database 240, estimate the number of planks that are needed to repair the fence.

Photos and videos can be annotated with contextual information to, for example, enhance the accuracy of the MAR module 320. For example, a human user, using a VR viewing device 280 for example, can review the image and confirm the existence, type and extent of damage to the property/structure. For example, the human user can digitally tag the “ceiling” with “leak” if such is present so that MAR module 320 can further learn how a ceiling leak appears in a digital image. The system according to an embodiment can append (relate) job-specific keywords and attributes to the image (e.g., roof replacements, geo, storm, flooding, cost of repair, job type, duration, etc.). Appending human annotation can be performed using software that allows for the review and annotation of images.

An embodiment can uniquely combine real estate and maintenance feedback loops (data- and human-powered judgment) in order to extend the value of commodity image recognition models for the purpose of allowing for the automatic detection of maintenance and real estate needs from pictures of property exteriors, property interiors, and other structures.

One or more embodiments of the invention can enable the collection and annotation of images and video to provide a machine-learned model for real estate maintenance and services. The application of this image recognition to maintenance and repair enables more automated processing (e.g., serving, pricing, etc.) and fulfillment of repair/maintenance requests. Additionally, system 200 can enable the collection of location data by using, for example, GPS associated with the client device 270 to estimate cost of services. Further, system 200 can enable estimation of cost through data collection and machine learning. By combining historical data and imagery, annotated or otherwise, with historical cost of work, system 200 can refine costing models for specific types of jobs to be more accurate and more automated in nature.

In a system according to an embodiment, which may include a processing device and a memory, one-way video call technology with an interactive video interface or a virtual reality headset enables a remotely located industry expert to diagnose, scope, and advise a property services customer. In operation, for example, a customer needs a service performed on a property and calls a service line accordingly. The customer is connected over a network to an expert in the field of property maintenance and services. The expert professional asks the customer to turn on a video call, or otherwise provide video/images, using, for example, a virtual-reality camera and show the expert professional the issue requiring diagnosis or the area where work is to be performed. In an embodiment, the VR camera is positioned to capture images of the property/structures to be serviced, and the captured images are processed using photogrammetric techniques to produce a digital VR environment characterizing the property/structures to be serviced and fully viewable using the VR viewing device 280. In an alternative embodiment, the one-way video call, may be performed using the customer's own personal phone camera. Using video or the VR viewing device 280, the property services expert is able to diagnose, scope, and/or advise the customer in real time.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. At least one computer-readable medium on which are stored instructions that, when executed by one or more processing devices, enable the one or more processing devices to perform a method, the method comprising the steps of:
receiving from a user one or more virtual-reality images of a structure;
performing on the image a first image recognition routine, the first image recognition routine identifying in the image a first object of which the structure is comprised;
performing on the image a second image recognition routine, the second image recognition routine identifying in the image one or more defects in the first object; and
generating an estimate of a type and quantity of material necessary to remedy the identified one or more defects.

2. The medium of claim 1, wherein the first image recognition routine identifies in the image a second object.

3. The medium of claim 2, wherein the method further comprises identifying at least one measured dimension of the second object.

4. The medium of claim 3, wherein the generated estimate is based on the at least one measured dimension of the second object.

5. At least one computer-readable medium on which are stored instructions that, when executed by one or more processing devices, enable the one or more processing devices to perform a method, the method comprising the steps of:
receiving from a user a request for performance of a service on a property;
receiving from a camera located on the property one or more virtual-reality images depicting at least a portion of the property;
identifying in the one or mare images one or more defects in the property; and
communicating one or more characteristics of the one or more defects to the user.

6. The medium of claim 5, wherein the method further comprises identifying at least one measured dimension of the defect.

7. The medium of claim 6, wherein the method further comprises generating an estimate of a type and quantity of material necessary to remedy the identified one or more defects based on the at least one measured dimension of the defect.
